(19) United States
(12) Patent Application Publication
(10) Pub. No.: US 2008/0077720 A1
(43) Pub. Date: Mar. 27, 2008

(54) Isochronous memory access with variable channel priorities and timers

(76) Inventor: Blaise Fanning, Folsom, CA (US)

Correspondence Address: SETH KALSON;c/o INTELLEVATE, LLC, P.O. BOX 52050, MINNEAPOLIS, MN, 55402, US

(21) Appl. No.: 11/528,025

(22) Filed: Sep. 27, 2006

(51) Int. Cl. G06F 13/14

(52) U.S. Cl. 710/240

(57) ABSTRACT

A memory controller to arbitrate memory request queues based upon priorities corresponding to the request queues, comprising logic to serve the request queue whose priority is equal to the maximum of the priorities. An embodiment may further comprise a timer corresponding to a request queue, where the priority of the request queue is changed from a low value to a high value if the timer expires while the request queue is not empty. In some embodiments, when the request queue is emptied after its timer has expired, the timer is set, and then started again once a new request enters the empty request queue.

### FIELD

Embodiments of the present invention relate to circuits that may be used in electrical computers and digital processing systems, and more particularly, to memory controllers that provide isochronous memory transactions.

### BACKGROUND

In a computer system, various devices, such as for example audio and video devices, may request at various times a group or packet of data bits at a specified memory address location. For such devices to perform to the user's expectation, a request should be serviced within some desired time latency from the time it is first generated. That is, when a request is first made, the time by which the requested data is retrieved from memory and sent to the device buffer should not exceed the desired time latency specific to the requesting device. It is not important to the user that the request is serviced in less time than the desired time latency, but only that the request is serviced at least within the time latency suitable for the device. Such time dependent requests (or transactions) may be referred to as isochronous requests (or transactions).

For each such device, there may be one or more channels of queued requests. A memory controller often includes an arbitration functional unit to determine the order by which queued requests are served. Typically, a memory controller may, for example, permanently establish priorities among the various channels; use time-slices to rotate the priority among the channels; or use a priority value provided with the request itself. As simple examples, an arbitration functional unit may give all isochronous channels fixed, highest priority, or may allocate a certain percentage of the available memory bandwidth for isochronous traffic.

It is of utility to provide a more flexible scheme in which priorities associated with channel request queues may be changed to provide isochronous transactions.

### BRIEF DESCRIPTION OF THE DRAWINGS

FIG. 1 illustrates an application of embodiments of the present invention to a computer system

FIG. 2 illustrates an embodiment of the present invention.

FIG. 3 illustrates the state diagram for a finite state machine according to an embodiment of the present invention.

FIG. 4 illustrates another embodiment of the present invention.

FIG. 5 illustrates another embodiment of the present invention.

### DESCRIPTION OF EMBODIMENTS

In the description that follows, the scope of the term “some embodiments” is not to be so limited as to mean more than one embodiment, but rather, the scope may include one embodiment, more than one embodiment, or perhaps all embodiments.

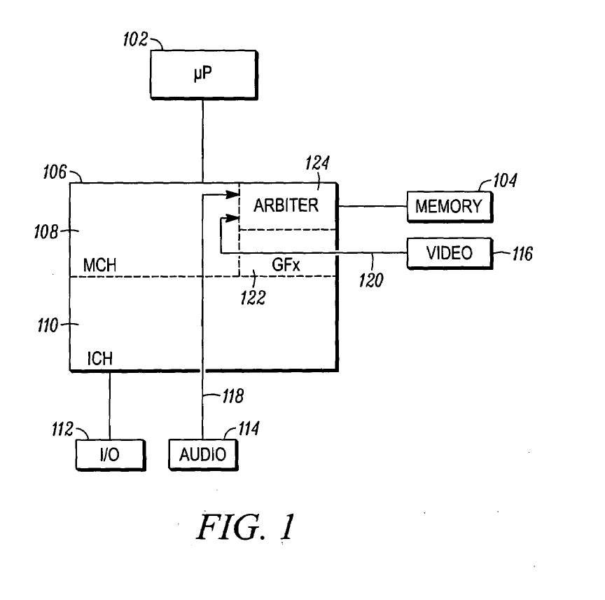

Before describing the embodiments, it is useful to first consider an application of the embodiments. Embodiments of the present invention find application in computer systems, but may be utilized in other electronic systems. FIG. 1 illustrates, in simplified form, a portion of a computer system in which an embodiment may find application.

Microprocessor 102 communicates with memory 104 via chipset 106. Two major functional units within chipset 106 are illustrated in FIG. 1 as memory controller hub (MCH) 108 and input/output controller hub (ICH) 110. MCH 108 provides communication with memory 104, and serves as a communication interface between microprocessor 102 and ICH 110. ICH 110 provides communication to various I/O communication devices, collectively represented by I/O device 112, such as USB (Universal Serial Bus, see www.usb.org) devices, internal hard disk drives, and network interfaces, as particular examples. As an example of an I/O device making isochronous requests, audio device 114 is shown. A data path representing traffic between audio device 114 and memory 104 is illustrated by data path 118.

Another example of a device making isochronous requests is video device 116, which makes requests to memory 104 for data to write to a video display. Video device 116 communicates to memory 104 by way of MCH 108. A data path representing traffic between video device 116 and memory 104 is illustrated by data path 120. Data paths 118 and 120 may be part of a single data communication bus. Other data paths are not shown for simplicity, but may include data paths for microprocessor 102, graphics functional unit 122, and other I/O devices. Arbiter 124 receives memory requests, and interfaces with memory 104 to retrieve the desired data that is indicated by the memory requests.

All or portions of chipset 106 may be integrated on the same die as microprocessor 102. Chipset 106 may represent a single die, or more than one discrete die. Some of the functional units in I/O device 112 may be integrated on chipset 106. For example, if I/O device 112 represents a network interface, then in some applications, the higher layers in a network communication protocol stack may be implemented inside chipset 106, whereas the physical layer may reside outside chipset 106.

Memory 104 may represent a hierarchy of memory, comprising one or more discrete die. In practice, memory 104 usually comprises DRAM (Dynamic Random Access Memory), and may also comprise SRAM (Static Random Access Memory.) A portion of memory 104 may reside on microprocessor 102.

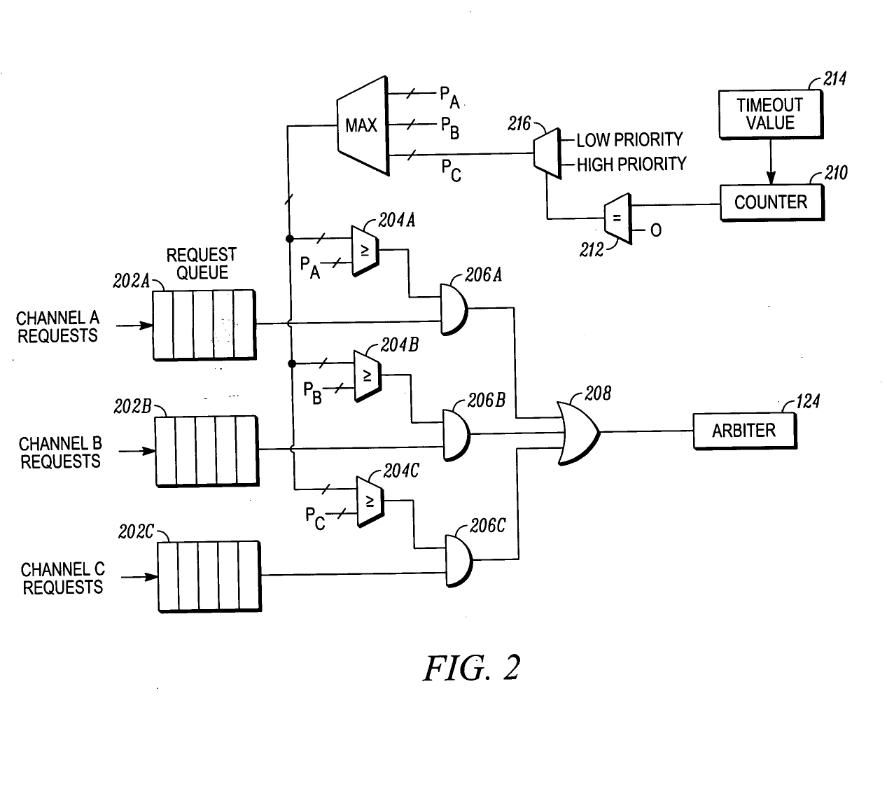

FIG. 2 illustrates an embodiment of the present invention. For simplicity, only three channel request queues are shown, request queue 202A for channel A requests, request queue 202B for channel B requests, and request queue 202C for channel B requests. Associated with each channel request queue is a priority, designated as priority P_{A} for channel A requests, priority P_{B} for channel B requests, and priority P_{C} for channel C requests.

These priorities are made available to comparators 204A, 204B, and 204C, where P_{A} is provided to an input port of comparator 204A, P_{B} is provided to an input port of comparator 204B, and P_{C} is provided to an input port of comparator 204C. Each of these comparators has another input port connected to the output port of functional unit MAX. The priorities P_{A}, P_{B}, and P_{C} are also provided to the input ports of functional unit MAX. Functional unit MAX provides as its output the maximum of the priorities. The priorities may, in general, be multi-bit valued, so that the various data paths providing these priorities may, in general, be multi-bit interconnects. A priority may be set to zero if its associated request queue is not in use.

Comparator 204A provides a HIGH, or logical 1, output if P_{A} is equal to the maximum of the priorities. If P_{A} is equal to the maximum of the priorities, then AND gate 206A simply passes to its output port the data bits stored in request queue 202A. Similarly, comparator 204B provides a HIGH, or logical 1, output if P_{B} is equal to the maximum of the priorities, and comparator 204C provides a HIGH, or logical 1, output if P_{C} is equal to the maximum of the priorities. If P_{B} is equal to the maximum of the priorities, then AND gate 206B passes to its output port the data bits stored in request queue 202B, and if P_{C} is equal to the maximum of the priorities, then AND gate 206C passes to its output port the data bits stored in request queue 202C.

If there is a unique maximum among the priorities P_{A}, P_{B}, and P_{C}, then OR gate 208 will pass to arbiter 124 those channel requests associated with the maximum priority. It may happen that the maximum is not unique. Accordingly, a number of schemes may be implemented. As one example, there may be an ordering among the index for the priorities, such as for example the ordering {A, B, C}. This ordering may be inherent in the structure of functional unit MAX, so that if a non-unique maximum is detected, then the least (relative to the ordering) index for which the priority is a maximum is provided to a bus to enable the corresponding comparator and to disable the rest. For example, if both P_{A} and P_{B} are equal to the maximum, and the ordering is {A, B, C}, then comparator 204A is enabled, and comparators 204B and 204C are disabled, so that channel requests from request queue 202A are provided to arbiter 124.

It may happen that a request queue is momentarily empty when its priority is the maximum. For such a case, various schemes may be implemented. A simple scheme is to do nothing. Under such a simple scheme, no requests are sent to arbiter 124 as long as the priority of the empty request queue is the unique maximum of the priorities. Another scheme is for functional unit MAX to provide the maximum of only those priorities for which their corresponding request queues are non-empty.

Similar schemes may be employed for the case in which a request queue is momentarily empty when its priority is a non-unique maximum and its corresponding comparator is enabled. As an example, again consider the case, as discussed earlier, where both P_{A} and P_{B} are equal to the maximum, and the ordering is {A, B, C}, but where request queue 202A is empty. Functional unit MAX may be configured so as to enable the comparator corresponding to the next ordered index, which in this example would be comparator 206B, and to disable the remaining comparators.

In this way, arbiter 124 serves at most only one request queue, where the priority corresponding to the served request queue is equal to the maximum of the priorities.

In the particular example of FIG. 2, priorities P_{A}, P_{B}, and P_{C} are provided as inputs to functional unit MAX. These values may be set in various ways, and may be a function of the particular device making requests. For example, a non-isochronous device may have some fixed priority, in which case its request queue is not serviced as long as there are other higher priority pending requests. For an isochronous device, a timer may be employed to elevate its priority when it is starved for data. An example of a timer for request queue 202C is illustrated in FIG. 2, comprising counter 210 and comparator 212

Counter 210 is loaded with programmable timeout value 214 each time request queue 202C is empty. When request queue 202C is not empty, counter 210 counts down toward zero. Comparator 212 compares the current value of counter 210 with zero. If the value of counter 210 is not equal to zero, comparator 212 provides a signal to multiplexer 216 so that P_{C} is set to a low priority. If counter 210 reaches zero, comparator 212 provides a signal to multiplexer 216 so that P_{C} is a high priority. Counter 210 remains at zero and priority P_{C} remains a high value until request queue 202C empties out, at which time counter 210 is again loaded with timeout value 214, and priority P_{C} once again is set to a low value. When a new request enters request queue 202C so that it is no longer empty, counter 210 again begins to count down.

In this way, the priority for request queue 202C is elevated only when request queue 202C has been non-empty for more than the timeout value 214. Timeout value 214 may be programmable, and may be provided by software, such as BIOS (Basic Input Output System) software. It is chosen so that requests are most likely serviced within the desired latency period for the device using request queue 202C.

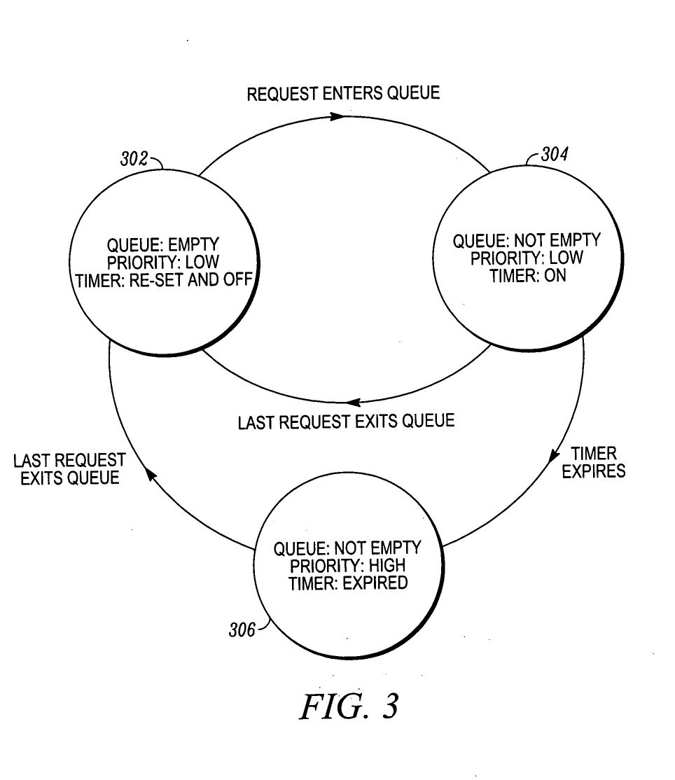

The interactions of a, timer, priority, and request queue as discussed in the above example describe a finite state machine illustrated in FIG. 3. Three states are identified in FIG. 3: state 302 in which the request queue is empty, the priority is low, and the timer is re-set and off; state 304 in which the request queue is not empty, the priority is low, and the timer is on (counting down); and state 306 in which the request queue is not empty, the priority is high, and the timer has expired. A request entering an empty queue changes the state from state 302 to state 304. From state 304, state 302 is entered if the request queue empties while the timer has not yet expired, and state 306 is entered if the timer expires before the request queue is emptied. From state 306, state 302 is entered when the last request exits the request queue.

Note from the finite state machine description of FIG. 3 that hysteresis is built in, so that once the priority is set high, it, stays high until the request queue is emptied.

Various modifications may be made to the disclosed embodiments without departing from the scope of the invention as claimed below. It should be appreciated that FIG. 2 illustrates an embodiment at a high level of abstraction utilizing logic gates to describe the functional relationship among various elements. Clearly, the functional relationships described in FIG. 2 may be realized by many different logic circuit implementations.

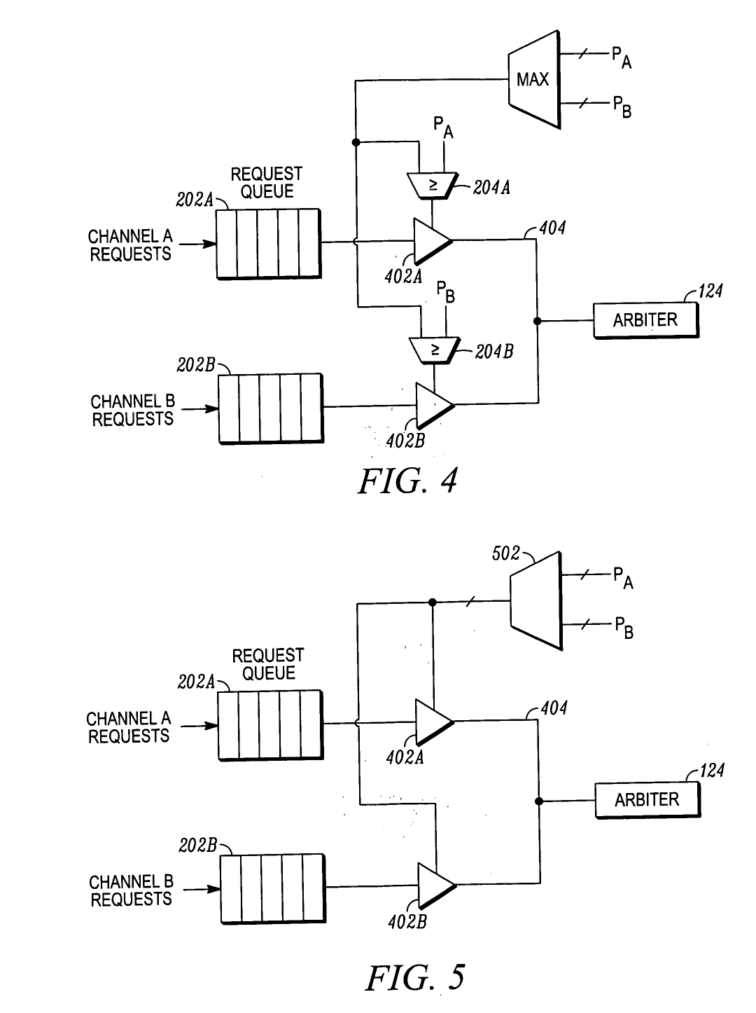

For example, FIG. 4 illustrates another embodiment at a high level, where for simplicity only two request queues are shown, and the timer structure is not shown. In FIG. 4, elements 402A and 402B are buffers that may be tri-stated by the outputs of comparators 204A and 204B, respectively. When P_{A} is equal to the maximum, buffer 402A is active so that it may drive interconnect 404, and comparator 204B tri-states buffer 402B so that it presents a very high impedance to interconnect 404. As a result, arbiter 124 is only responsive to the requests in request queue 202A. Similarly, when P_{B} is equal to the maximum, buffer 402B is active so that it may drive interconnect 404, and comparator 204A tri-states buffer 402A so that it presents a very high impedance to interconnect 404. As a result, arbiter 124 is only responsive to the requests in request queue 202B. The case when both P_{A} and P_{B} are equal to the maximum may be handled as discussed earlier.

As another example of an embodiment, the state diagram in FIG. 3 may be defined differently. As one example, in state 302 the timer may be left expired, where it is re-set upon entering state 304. In yet other embodiments, counter 210 may count up instead of down, where comparator 212 compares the counter value to timeout value 214 instead of 0, and changes P_{C} to a high priority when the counter value exceeds timeout value 214. Counter 210 is re-set by setting its counter value to zero. Generally, counter 210 may be described as a finite state machine that sequences through a sequence of states, such that P_{C} is changed when a state is reached indicating that the timer comprising counter 210 has expired.

In yet other embodiments, a single functional unit may provide signals to various pass gates, or buffers, so that the request queue having the maximum priority may be served by arbiter 124. An example is illustrated in FIG. 5. FIG. 5 is similar to that of FIG. 4, except that functional unit 502 integrates the functions of functional unit MAX and comparators 204A and 204B. Functional unit 502 enables either buffer 402A or 402B, depending upon which one has the largest corresponding priority. This example illustrates that functional units may be defined in various ways.

It also should be clear to one of ordinary skill in the art that gating may be employed in the disclosed logic circuit implementations to avoid glitches when the numerical relationships among the priorities change, so that at most only one request queue is served by arbiter 124 at any given time.

In the claims, various mathematical relationships may be used to describe relationships among one or more quantities. For example, a mathematical relationship or mathematical transformation may express a relationship by which a quantity is derived from one or more other quantities by way of various mathematical operations, such as addition, subtraction, multiplication, division, etc. Or, a mathematical relationship may indicate that a quantity is larger, smaller, or equal to another quantity. These relationships and transformations are in practice not satisfied exactly, and should therefore be interpreted as “designed for” relationships and transformations. One of ordinary skill in the art may design various working embodiments to satisfy various mathematical relationships or transformations, but these relationships or transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

What is claimed is:

1. A circuit comprising:
an arbiter to service memory requests; and
a request queue having a corresponding priority, the arbiter to service memory requests in the request queue only if the priority is equal to a maximum of a set of priorities.

2. The circuit as set forth in claim 1, further comprising:
a set of request queues, the set of request queues in one-to-one correspondence with the set of priorities, where the request queue is a member of the set of request queues.

3. The circuit a set forth in claim 1, further comprising:
a timer to change the priority to a high value when the timer expires.

4. The circuit as set forth in claim 3, further comprising:
a set of request queues, the set of request queues in one-to-one correspondence with the set of priorities, where the request queue is a member of the set of request queues.

5. The circuit as set forth in claim 3, wherein the timer is on only if the request queue is not empty.

6. The circuit as set forth in claim 5, wherein the timer sets the priority to a low value, less than the high value, when the timer has expired and the request queue is empty.

7. A circuit comprising:
a request queue having a corresponding priority; and
a finite state machine having a first state where the request queue is empty and the priority is a low value; having a second state where the request queue is not empty and the priority is the low value, and having a third state where the request queue is not empty and the priority is a high value, larger than the low value.

8. The circuit as set forth in claim 7, the finite state machine to change from the second state to the first state when the request queue is emptied.

9. The circuit as set forth in claim 7, further comprising:
a second finite state machine to sequence through a set of states, the set of states comprising a first state and a second state, the finite state machine to change from the second state to the third state when the second finite state machine has sequenced from the first state to the second state.

10. The circuit as set forth in claim 9, the finite state machine to change from the second state to the first state when the request queue is emptied.

11. The circuit as set forth in claim 9, the finite state machine to change the state of the second finite state machine to the first state, and the finite state machine to change from the first state to the second state when a first request enters the request queue.

12. The circuit as set forth in claim 11, the finite state machine to change from the second state to the first state when the request queue is emptied.

13. The circuit as set forth in claim 7, further comprising:
an arbiter to serve the request queue only if the priority is equal to a maximum of a set of priorities.

14. The circuit as set forth in claim 8, further comprising:
an arbiter to serve the request queue only if the priority is equal to a maximum of a set of priorities.

15. The circuit as set forth in claim 9, further comprising:
an arbiter to serve the request queue only if the priority is equal to a maximum of a set of priorities.

16. A computer system comprising:
memory; and
a memory controller in communication with the memory, the memory controller comprising a request queue to store memory requests indicating memory locations in the memory, the request queue having a corresponding priority, wherein data is retrieved from the memory at the requested memory locations only if the priority is equal to a maximum of a set of priorities.

17. The computer system as set forth in claim 16, further comprising:
a set of request queues, the set of request queues in one-to-one correspondence with the set of priorities, where the request queue is a member of the set of request queues.

18. The computer system a set forth in claim 16, further comprising:
a timer to change the priority to a high value when the timer expires.

19. The computer system as set forth in claim 18, further comprising:
a set of request queues, the set of request queues in one-to-one correspondence with the set of priorities, where the request queue is a member of the set of request queues.

20. The computer system as set forth in claim 18, wherein the timer is on only if the request queue is not empty.

21. The computer system as set forth in claim 20, wherein the timer sets the priority to a low value, less than the high value, when the timer has expired and the request queue is empty.
